(19) United States
(12) Patent Application Publication
(10) Pub. No.: US 2025/0351085 A1
(43) Pub. Date: Nov. 13, 2025

(54) ADAPTIVE LINK STATUS AND CONFIGURATION PER THE APPLICATION TRAFFIC PATTERN FOR UE POWER SAVING

(71) Applicant: Samsung Electronics Co., Ltd., Suwon-si (KR)

(72) Inventors: Vutha Va, Plano, TX (US); Yuqiang Heng, Plano, TX (US); Anum Ali, Frisco, TX (US); Boon Loong Ng, Plano, TX (US)

(21) Appl. No.: 19/007,335

(22) Filed: Dec. 31, 2024

Related U.S. Application Data
(60) Provisional application No. 63/646,187, filed on May 13, 2024.

(51) Int. Cl. H04W 52/02; H04W 76/28; H04W 76/30

(52) U.S. Cl. CPC H04W 52/0261; H04W 76/28; H04W 76/30

(57) ABSTRACT

A method and device for adaptive link status and configuration per the application traffic pattern for UE power saving. The method includes determining whether a UE power saving parameter is met. When the UE power saving parameter is met, performing a link management solution that includes an early link release procedure for releasing a link and reducing UE power consumption. When the UE power saving parameter is not met, not performing the link management solution that includes the early link release procedure for releasing the link and reducing UE power consumption.

### CROSS-REFERENCE TO RELATED APPLICATION AND CLAIM OF PRIORITY

This application claims priority under 35 U.S.C. § 119 (e) to U.S. Provisional Patent Application No. 63/646,187 filed on May 13, 2024, which is hereby incorporated by reference in its entirety.

### TECHNICAL FIELD

This disclosure relates generally to wireless communication, and more specifically to user equipment (UE) power consumption including adaptive link status and configuration per the application traffic pattern for UE power saving.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Cellular modem power consumption is a factor affecting the user experience of a mobile device as it directly impacts the battery life of the device. As such there are efforts in the cellular specifications (by the 3GPP) aiming to reduce the power consumption of the user equipment (UE). In Release 16 of the 5G NR (Fifth Generation New Radio) specifications, a feature called UAI (UE Assistance Information) was introduced that allows the UE with the knowledge of the applications running on its side to adjust some cellular link parameters so that the user experience is maintained while saving the UE power. This feature allows the UE to convey desired link configuration that includes but is not limited to: delay budget; overheating assistance information; in-device coexistence; preferred discontinuous reception configuration; preferred maximum aggregated bandwidth; preferred maximum number of secondary control channels (CCs); preferred maximum number of MIMO layers; preferred scheduling offset and cross-slot scheduling; and preferred radio resource control (RRC) state, and offers an opportunity for optimizing cellular link for a class of discontinuous data traffics that are bursty (e.g., streaming applications) or sporadic in nature.

### SUMMARY

Embodiments of the present disclosure provide methods and devices for adaptive link status and configuration per the application traffic pattern for UE power saving.

In one embodiment, a method performed by a UE comprises determining whether a UE power saving parameter is met; when the UE power saving parameter is met, performing a link management solution that includes an early link release procedure for releasing a link and reducing UE power consumption; and when the UE power saving parameter is not met, not performing the link management solution that includes the early link release procedure for releasing the link and reducing UE power consumption.

In another embodiment, a UE comprises a transceiver, and a processor operably coupled to the transceiver. The processor configured to: determine whether a UE power saving parameter is met; when the UE power saving parameter is met, perform a link management solution that includes an early link release procedure for releasing a link and reducing UE power consumption; and when the UE power saving parameter is not met, not perform the link management solution that includes the early link release procedure for releasing the link and reducing UE power consumption.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of bursty traffic for a streaming application and the potential power saving by reducing the unnecessary RRC tail time after each data burst according to embodiments of the present disclosure;

FIG. 5 illustrates an example of a gating mechanism for determining whether the link management solution should be enabled according to embodiments of the present disclosure;

FIG. 6 illustrates an example with a traffic type analyzer that assesses if the traffic for the given target application has potential for UE power saving or not according to embodiments of the present disclosure;

FIG. 7 illustrates an example for a link status management procedure to save the UE power according to embodiments of the present disclosure;

FIG. 8 illustrates an example packet trace for a video streaming application according to embodiments of the present disclosure;

FIG. 9 illustrates an example of how to obtain training data for a machine learning (ML) solution to determine whether the link could be released or not according to embodiments of the present disclosure;

FIG. 10 illustrates an example where a ML recommender is combined with a rule-based solution derived from expert knowledge of the operation of the application and the finer-grained from the application according to embodiments of the present disclosure;

FIG. 11 illustrates an example for managing the link connection status using the estimated time that the application will not need the communication link according to embodiments of the present disclosure;

FIG. 12 illustrates an example that leverages the burst size estimate provided by the application to adjust the UAI parameters for UE power saving according to embodiments of the present disclosure;

FIG. 13 illustrates an example where network throttling may be detected by the modem/device and shared with the application according to embodiments of the present disclosure;

FIG. 14 illustrates an example for managing the streaming video buffer using the mobility status from the modem/device's API according to embodiments of the present disclosure; and

FIG. 15 illustrates an example method for adaptive link status and configuration per the application traffic pattern for UE power saving according to embodiments of the present disclosure.

### DETAILED DESCRIPTION

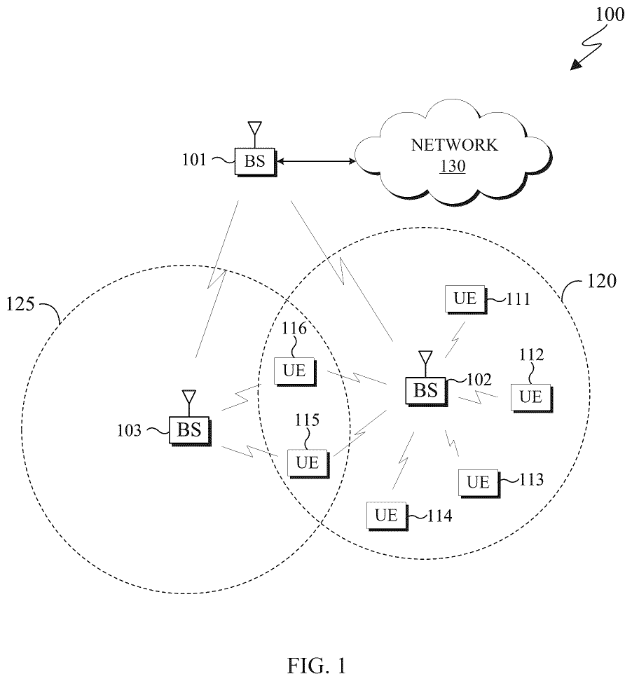

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that cellular modem power consumption is a factor affecting the user experience of a mobile device as it directly impacts the battery life of the device, and that applications running on the mobile device affect power consumption.

Accordingly, embodiments of the present disclosure can provide methods and apparatuses for managing the cellular link status using knowledge of the application traffic patterns to save UE power.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

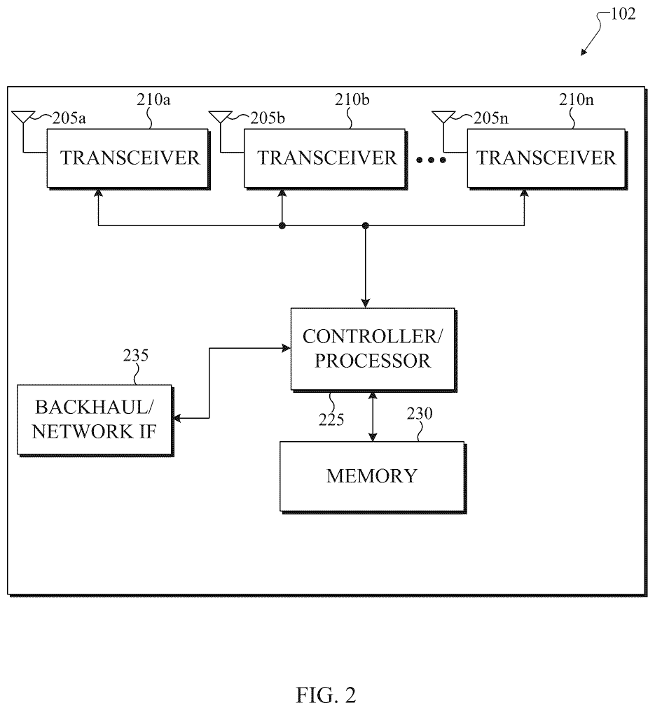

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating adaptive link status and configuration per the application traffic pattern for UE power saving. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

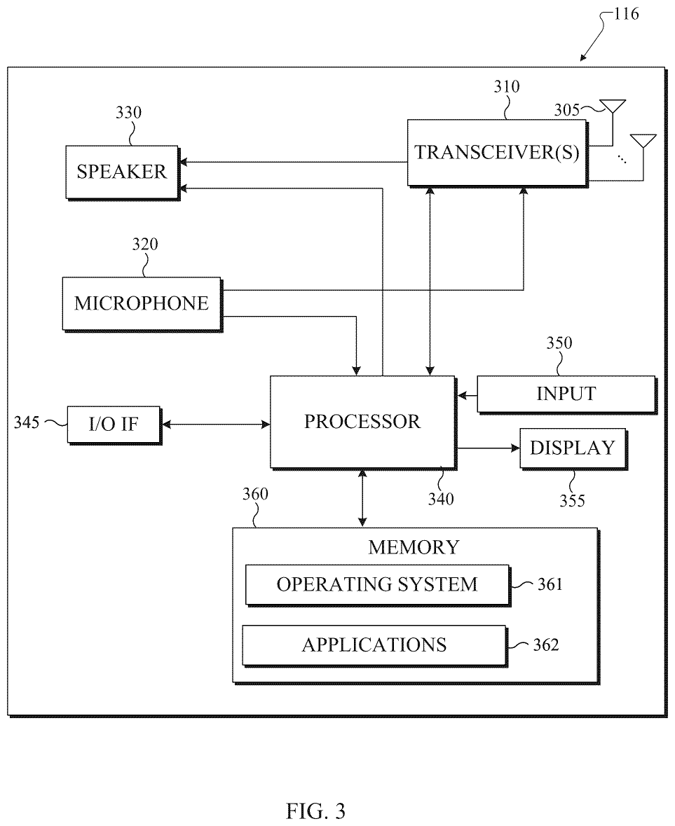

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating adaptive link status and configuration per the application traffic pattern for UE power saving. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

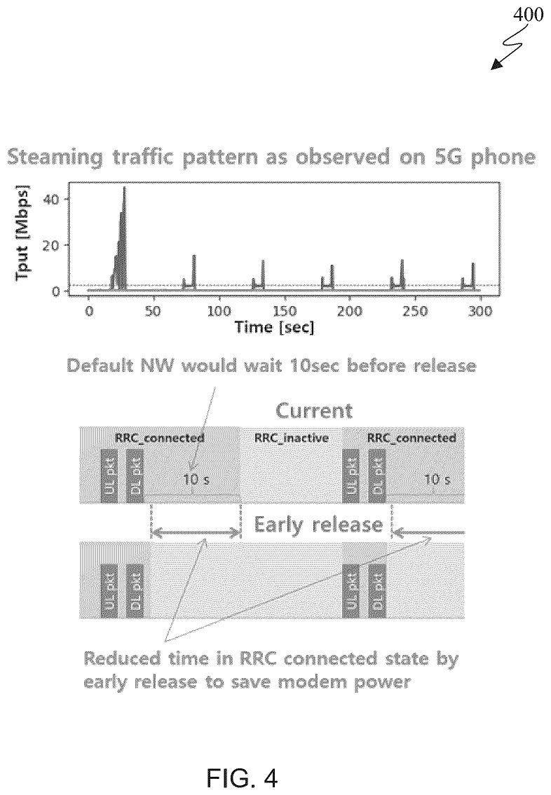

FIG. 4 illustrates an example of bursty traffic for a streaming application and the potential power saving by reducing the unnecessary RRC tail time after each data burst 400 according to embodiments of the present disclosure. The embodiment of the example of bursty traffic for a streaming application and the potential power saving by reducing the unnecessary RRC tail time after each data burst 400 illustrated in FIG. 4 is for illustration only. Other embodiments of the example of bursty traffic for a streaming application and the potential power saving by reducing the unnecessary RRC tail time after each data burst 400 could be used without departing from the scope of this disclosure.

In a cellular system, the UE connected to the BS can be in one of multiple states including the connected state and the idle state. The connection state is commonly referred to as the RRC (Radio Resource Control) state. Following a UE data transmission or reception, the BS may apply an inactivity timer, where the RRC link connection may be released if the user has no data activity longer than the inactivity timer. We refer to the time following the last data activity until the link release as the RRC tail.

As illustrated in FIG. 4, using the preferred RRC state (a component of UAI feature) offers an opportunity for optimizing the cellular link for a class of data traffics that are bursty (e.g., streaming applications) or sporadic in nature. For this type of discontinuous data traffic, the cellular link may be set to a connected state when it is active in data communication, and the link may be set to idle with longer latency but lower power consumption during the idle time in between data bursts. Using the 3GPP terms, the connected state refers to the RRC-connected state and the idle state refers to either the RRC-Idle or RRC-inactive state as defined in the 5G specifications. However, in existing cellular systems, the management of the state of the link is left entirely to the network (NW) side. Typically, the NW would apply a generic and common rule to all UE regardless of their actual applications. For example, a commonly observed rule seen in actual data traces is that the NW would apply a simple wait time rule: if there is no data activity (both uplink and downlink) for 10 sec, the NW would release the UE's RRC connection and send it to the idle state. Given the knowledge of the traffic patterns, this approach is a too simplistic and non-optimal solution. The UE having knowledge of the traffic patterns running at its side can detect the data burst-end and using UAI, it can request the RRC release right after the detection which can reduce the unnecessary time in the connected state, which in some embodiments can reduce up to 10 seconds of time unnecessarily in the connected state per the earlier example described above. Because the UE consumes more power in the connected state compared to the idle state, the reduction in the time duration in the connected state means lower power consumption. An illustration of this is shown in FIG. 4.

Embodiments of the present disclosure describe managing the cellular link status (which can be the connected or idle state) that saves UE power while not degrading user experience. In 5G, the connected state is the RRC connected state, and the present disclosure considers both the RRC-idle and RRC-inactive as the idle state. One main difference between the RRC-idle and RRC-inactive in 5G is whether the core network context of the UE is maintained or not, and this has implication on the overhead of link establishment and the latency. Regardless of the two states, embodiments described herein are applicable, with some possible refinement to align with the network constraint if one of these two states is used.

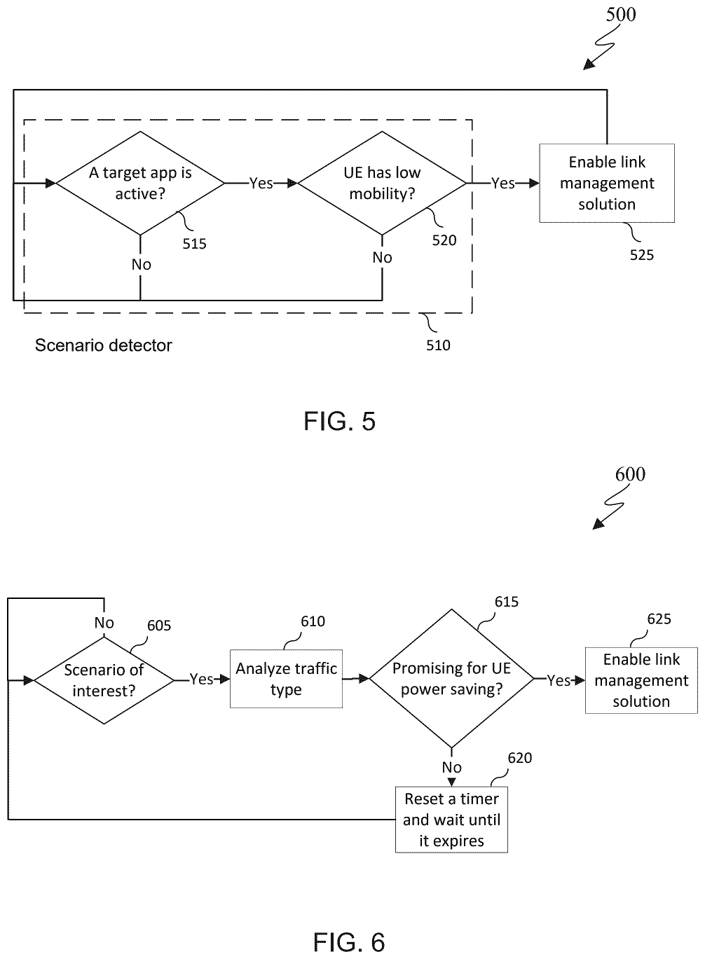

FIG. 5 illustrates an example of a gating mechanism 500 for determining whether the link management solution should be enabled according to embodiments of the present disclosure. The embodiment of the gating mechanism 500 for determining whether the link management solution should be enabled illustrated in FIG. 5 is for illustration only. Other embodiments of the gating mechanism 500 for determining whether the link management solution should be enabled could be used without departing from the scope of this disclosure.

As illustrated in FIG. 5, in one embodiment, a gating mechanism 500 could be introduced to detect the scenario where UE power saving is promising and only then is the link management solution is enabled. This way, wasting of resources can be avoided for running the link management solutions when the potential power saving is low. The desirability of the scenarios may depend on various factors that may include the power consumption characteristics of the modem, cost for running the link management solution, and the sensitivity of the applications to the variability of the data link connection. In one implementation, for a certain set of target apps, predictability of the cellular link condition may be important to achieve power saving while maintaining the desired user experience. For example, this may mean a scenario where the UE has low mobility. An example embodiment is shown in FIG. 5, where the gating mechanism 500 includes a scenario detector procedure 510 coupled to a link management solution procedure 525.

During operation, the gating mechanism 500 may determine, at 515, whether the currently active app is an app within a list of targeted apps. The targeted apps could be selected based on the apps' characteristics. For example, non-real-time applications like streaming applications could have bursty traffic patterns with some regularity (e.g., bursts are somewhat periodic under stable network condition for example as show in FIG. 4). If the currently active app is not an app within the list of targeted apps, then the link management solution procedure 525 is not enabled. If the currently active app is an app within the list of targeted apps, then to further ensure that the traffic patterns are stable, there could be an additional condition on the stability of the cellular link. One condition affecting this may be the mobility of the UE, and thus, at step 520, a determination is made whether the UE has low mobility. If a determination is made that the UE has low mobility, then the scenario may be considered promising for applying the link management solution to save UE power, and at step 525, the link management solution is enabled. If a determination is made that the UE does not have low mobility, then the scenario may be considered not promising for applying the link management solution to save UE power, and the link management solution procedure 525 is not enabled. In some embodiments, the scenario detector may be run as an event-triggered solution where the scenario detection is run when an app is opened (or becomes active) and/or when there is a change in the mobility status.

In some embodiments, applications with sporadic data communication or bursty-but-less-regular traffic may also be a good target for UE power saving with cellular link management. Some of those applications may include but not be limited to instant messaging apps (this could depend on the user's usage behavior as well), web browsing, music streaming, etc. Background traffic only when the device is in a doze state (e.g., screen off, and no user's interaction) may also be a good target for power saving with proper link status management.

FIG. 6 illustrates an example 600 with a traffic type analyzer that assesses if the traffic for the given target application has potential for UE power saving or not according to embodiments of the present disclosure. The embodiment of the example 600 with a traffic type analyzer that assesses if the traffic for the given target application has potential for UE power saving or not illustrated in FIG. 6 is for illustration only. Other embodiments of the example 600 with a traffic type analyzer that assesses if the traffic for the given target application has potential for UE power saving or not could be used without departing from the scope of this disclosure.

For some of these applications, the data traffic patterns could vary depending on the current usage of the app. For example, some streaming applications offer both video-on-demand and live-streaming. For the video-on-demand streaming, it may operate with clear bursty patterns, while for the live-streaming option, the traffic could be mostly persistent and leaving very little if any room for power saving by optimizing the link status management. To overcome this, a traffic type analysis procedure 610 that is configured to analyze traffic type may be introduced as shown in FIG. 6. The traffic type analysis procedure 610 may analyze the traffic to determine the potential for power saving via link status management.

For example, during operation, at step 605, a determination may be made whether the current scenario is a scenario of interest. If the current scenario is not a scenario of interest, then no further action may be taken. If the current scenario is a scenario of interest, then the traffic type may be analyzed by the traffic type analysis procedure 610. In some embodiments, the traffic type analysis procedure may determine if the traffic is bursty and if so it may also compute the average and variance of burst interval. For a given power consumption model for the modem, this basic information can be used to estimate the potential power saving when applying the link status management solution. For example, at step 615, a determination may be made whether the power saving potential of the currently running service is promising. If it is determined at 615 that the power saving potential of the currently running service is not promising or low (e.g., when the user is viewing a live-streaming service), then it is likely that the traffic remains in this state until the user makes the change. Considering this situation, for better efficiency, a timer may be set at 620 and a delay or wait until the timer expires may occur before attempting to check the traffic again. Alternatively, if the change in the usage of the app (e.g., when there is a video change) can be detected or known to the modem, it may use an event-trigger rather than a timer for rechecking the traffic type. If it is determined at 615 that the power saving potential of the currently running service is promising or high, then the link management solution procedure 625 may be enabled.

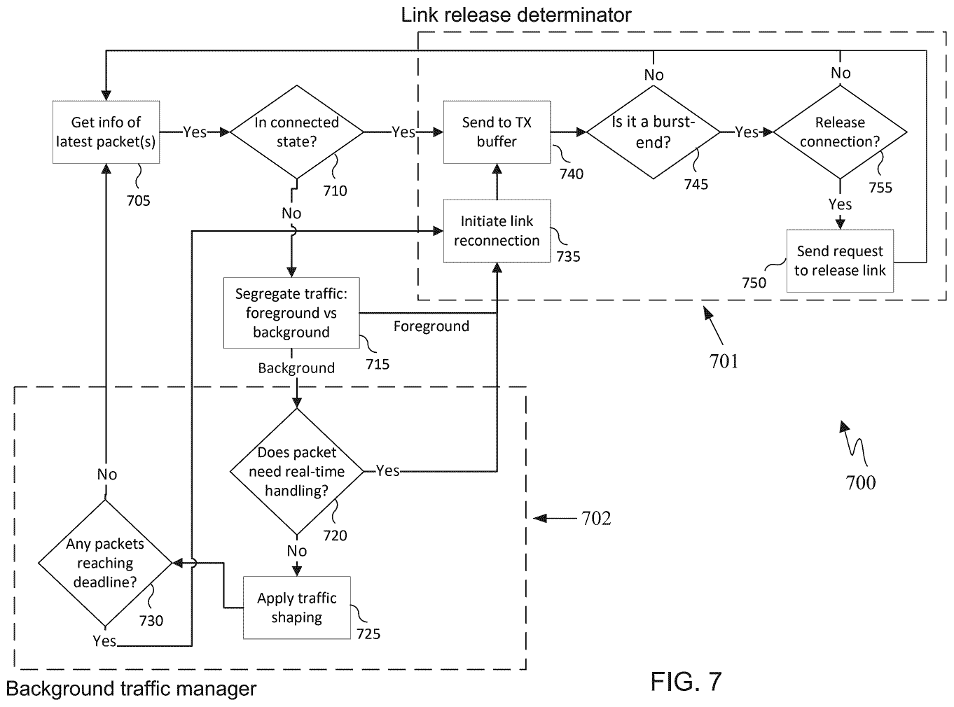

FIG. 7 illustrates an example of a link status management procedure 700 to save the UE power according to embodiments of the present disclosure. The embodiment of the example for a link status management procedure 700 to save the UE power illustrated in FIG. 7 is for illustration only. Other embodiments of the example for a link status management procedure 700 to save the UE power could be used without departing from the scope of this disclosure.

As illustrated in FIG. 7, in this embodiment, at a high level there may be two main components: a link release module 701 and a background traffic management module 702. The link release module 701 is a module to determine whether to release the link (i.e., transition from the connected to the idle state), and may determine when the link can be released without affecting the performance to save the power. The link release module 701 may include one or more submodules including a submodule to determine whether a data burst-end has been reached and another submodule to determine whether the link can be released at this burst-end. The background traffic management module 702 is a module configured to manage background traffic, and aims to maximize the power saving by adjusting the timing of background packet transmission whenever allowed. This is referred to herein as traffic shaping.

Prior to entering the link release module 701 or the background traffic management module 702, the link status management procedure 700 may include receiving information about the most recent packets at step 705, and determining whether the link is in the connected state at step 710. If the link is in the connected state, then the packets may be sent to the transmit buffer at step 740. At step 745, a determination may be made whether a data burst end is detected. If a data burst end is detected, then at step 755, a determination may be made whether the connection should be released. If a determination is made that the connection should be released, then at step 750, a request to release the link is sent. If a data burst end is not detected, then the procedure may revert to step 705. Similarly, if the connection should not be released, then the procedure may revert to step 705. If the link is not in the connected state at step 710, then the incoming traffic (in the uplink) may be segregated into foreground and background packets at step 715.

There can be multiple approaches to detect a data burst-end. For example, one approach could be a rules-based method that bases the determination on a definition of a burst. For example, in one embodiment, a data burst may be defined as a set of packets where each packet is separated from its neighbor by less than a time threshold T. In this example, one would only need to check the time since the last packet and if the time is larger than T, then it may be determined that a burst-end is detected. The threshold T may be selected to balance the power saving and the number of link state transitions (which may introduce more overhead at the NW side as well as additional power consumption at the UE); some possible values may include 0.1 sec, 0.5 sec, 1 sec, etc. Once a burst-end is detected, there can be another module to determine whether to release the link at this time. One solution may be to just always release the link whenever a burst-end is detected. However, further optimization could be done at this stage. In one implementation, some constraint on the number of state transitions could be imposed. One solution may be to set a timer after each link release. In this implementation, another release cannot be made until the timer expires. Another approach could be to put the constraint on the number of link releases within a past time window (e.g., the last 30 sec). If the number of link releases has reached a set threshold, then a release might not be allowed. The burst-end determination may also consider whether the data packets are foreground or background, since the properties of the foreground and background traffics could be different. For example, for background traffic, packets could tend to be isolated and sporadic, in which case a shorter timer threshold could be used for determining a burst-end. Other approaches that may also include the use of machine learning solutions may also be used. Further, the two submodules described above may be combined into a single module.

Foreground traffic generated from the currently active app is typically the dominant traffic. At the same time, other apps on the device that are not being actively used by the user at the current time may also generate some communication traffic for some purposes such as data sync to keep up to date with the server in the cloud. Many of these background packets could be generated completely independently without any coordination (e.g., in the timing) with the active app. Due to this, there could be situations where the background packets could be generated in the middle between the data burst of the foreground traffic. This would require the UE to transition to the connected state to send those background packets before it can release the link again. This would require another link reestablishment and depending on the burst-end detection it may add some non-negligible time that the UE needs to stay in the connected state unnecessarily. This would negate the UE power saving. Thus, to maximize or increase the power saving, the background traffic may be managed.

As described above, the incoming (uplink) traffic may be segregated into foreground and background packets at step 715. For foreground packets, they may need to be sent right away, and the procedure may initiate a link reestablishment at step 735 to get back to the connected state and send those out. In this case, if there are some packets in the traffic shaping buffer, they may also be sent out following the foreground packets. For background packets, first it is determined whether the packet needs real-time handling at step 720. There could be various approaches to make this determination. For example, consider an Android system, background tasks could be scheduled by a job scheduler that may define the timing requirement of the task execution. Specifically, a job may be defined as periodic with some flexible time window for transmission, or it could be set to expedited for faster transmission. If a background packet does not need real-time handling, it means that it is safe (meaning no negative impact on the performance/user experience) to apply traffic shaping on it at step 725 and there is no need to reestablish the link to transition back to the connected state. In this case, the packet is added to a buffer for traffic shaping, where those packets are delayed to be sent at a later time to facilitate the power saving. However, some of these packets may still have some deadline. Thus, after adding to the traffic shaping queue, the procedure may check the queue to see if there might be one or more packets that reach the deadline for their transmission at step 730. If there are one or more packets that reach the deadline for their transmission, then those packets with the current deadline would be treated as packets that require real-time handling. In this case, link reestablishment is initiated at step 735 and those packets are sent at step 740. In some implementations, all other packets in the traffic shaping buffer may also be sent out at this time. If there are not one or more packets that reach the deadline for their transmission at step 730, then the procedure reverts to step 705.

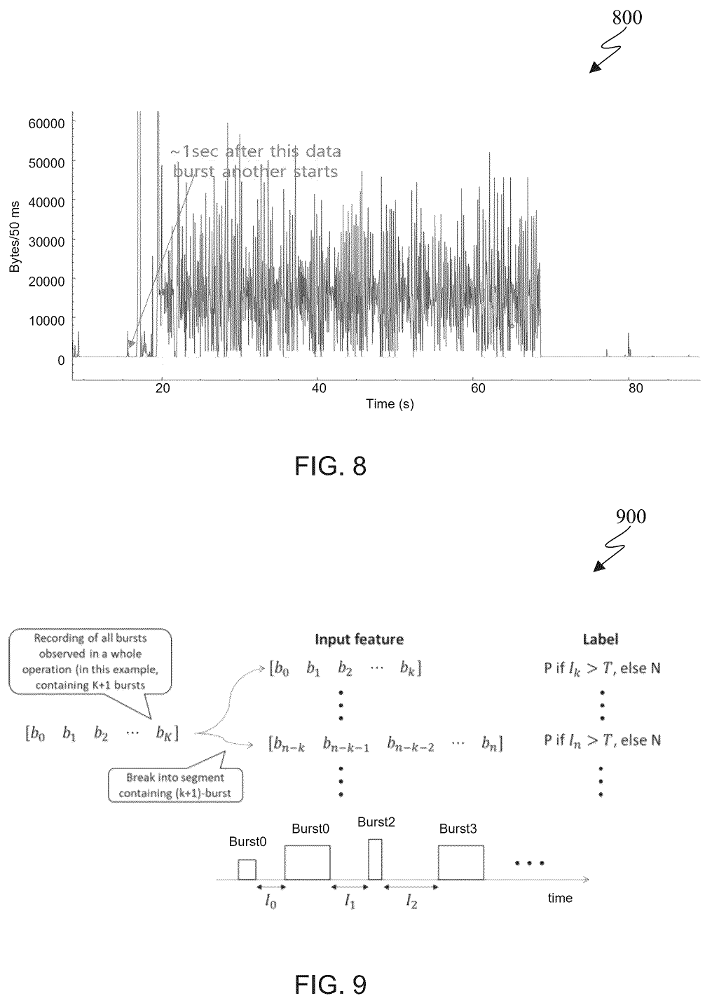

FIG. 8 illustrates an example packet trace for a video streaming application 800 according to embodiments of the present disclosure. The embodiment of the example packet trace for a video streaming application 800 illustrated in FIG. 8 is for illustration only. Other embodiments of the example packet trace for a video streaming application 800 could be used without departing from the scope of this disclosure.

In the embodiments described above, the cellular modem on the UE optimizes the link status management without any information exchange with the foreground app. For example, the UE detects a burst-end based on some rule-based solution or some learning solution observed from the traffic patterns of the target app(s). While this could work well in most cases, such a detection may not be accurate enough in some cases. For example, an example trace from a streaming app is shown in FIG. 8 that illustrates a small data burst right before another large data burst as illustrated by the arrow in the figure. This small data burst has a small separation of less than 1 sec to the next data burst. Observing the data traffic without any knowledge from the app, it may be likely that a burst end could be declared after that small data burst. In this case, it would create an additional connection state transition with very limited potential for power saving due to the short time duration before the next big data burst. Another potential issue is that this small data burst might be used only for control to facilitate the video segment fetching (e.g., the big data burst) and thus due to the need for reestablishment in this case, there could be some added latency to the video segment fetching, which may cause some video stalling depending on the current video buffer status.

Exchanging information between the target app and the modem could create synergy between the two sides and could help save the UE power while improving the user experience of the target app (e.g., a better video streaming experience). Accordingly, embodiments described below include the following categories for collaboration between the target app and the modem.

When the target app shares information related to its data communication: In this category, the app could open some application programming interface (API) so the modem could obtain some basic information such as the end of data burst and data burst types (e.g., control packets or data packets), which can eliminate the need for blind detection of the burst-end that could introduce error. The modem could be expected to better optimize the UE power saving and facilitate the communication needs of the target app which could result in better user experience for the app.

When the target app shares information and may also adapt its data communication strategy: In addition to the app sharing information to the modem, the modem could open an API for the app to convey its data communication needs (e.g., whether it needs the data link or not at the moment and could possibly schedule a future data communication need). This could allow the app to optimize its data usage while at the same time also help the modem to manage the link for power saving. Further, the modem may also provide information on the data link (such as throttling placed by the NW) that could be helpful for the app to adapt its data communication strategy. As one example, consider a streaming application. If throttling is known, the app could send a push notification to the user informing them that due to NW throttling, the streaming at the current video resolution could be unstable and it could recommend a lower resolution for better overall streaming experience.

When the app shares information related to its data communication: For certain types of applications, the data demand could be readily known, possibly well in advance, to the applications. One example is video streaming applications. A common protocol for video streaming would define a video meta data (e.g., what is called the video manifest in the DASH protocol) that conveys information such as how the video is broken down into segments and what are available video qualities (e.g., different resolutions). The protocol would adapt some streaming strategy that manages the video buffer for optimal streaming experience. For example, it would try to maintain a certain level of video buffer (e.g., between 20 sec and 100 sec) where it would initiate the fetching of a new video segment when the video buffer depletes below some lower threshold. Thus, knowing the video manifest, the current video buffer status, and the condition for triggering data fetching for the next segment would be enough to know the timing when data communication is needed and possibly how much data is needed. While in practice different streaming services might adapt different strategies with varying complexity, the basic operation is expected to be the same as described herein in this simple streaming example. A similar approach could be taken for other services that operate similarly such as audio streaming (e.g., on-demand music, podcast, etc.).

In some embodiments, an API could be defined for the app (e.g., a video streaming application) to share information related to its data communication that could be helpful for the modem to optimize the power consumption and the modem could facilitate the data communication that could improve the app's user experience. One API may define and share the following information:
Indicator of data-burst end: This could be available at or after the last packet in a data burst. The burst end here could be simply defined as when there is no packet at least T see after the last packet. For example, after the completion of the download of a video segment and the buffer status is high enough, the app may decide not to do another request to fetch the next segment. If there is no other link maintenance packet to be sent, then it can be expected that there will be no packet for a while. In this case, the app can indicate after the last packet of the segment that it is the end of the current data burst.
Data-burst type: This could be helpful as the behavior of user data and control messages could be different. For example, for a streaming application, the user data is the video data and control messages could be those messages for managing the streaming buffer or for maintaining the health of the current data link(s) or its alternatives.

With this kind of burst-end indicator provided by the app, the early release solution can have very low complexity for managing the link connection status as it no longer needs to detect burst-ends. Further, a data burst-end indicator provided by the app can be more accurate. For example, consider a situation where there could be some issue in the server that causes the data downloading to pause for a few hundred milliseconds. If the data burst-end detector confuses this pause as a burst-end it could trigger some undesirable link release and reestablishment, which could create an undesired latency and cost associated with the connection state changes. The app, however, would understand well that this is not a burst-end, as it is expecting more data packets to come.

In this category of collaboration, the burden on the app is minimal as the app is only being asked to share some information related to its current data communication at the time when relevant packets are being sent. In principle, the app just needs to read and expose those pieces of information to the modem. No additional calculation or inference is needed on the fetched information.

With this kind of API, while some likely confused burst-end cases (e.g., the example described above where a short blank in data fetching could be confused as a burst-end) could be avoided with the information shared by the app, there could still be unclear situations where the data burst could end, but shortly after there could be another data burst to follow. These consecutive data bursts could be of different nature; e.g., some bursts to fetch some meta data for the streaming while other bursts could be for fetching the video segments. In some implementations of the API, the app may indicate the type as either data (meaning the main user data; e.g., for a streaming application this would be the video segment) or control (which could be those packets for link maintenance or it could include the packets for streaming/buffering management, especially when they are sent as separate bursts).

A learning approach could be used to fill in the gap of knowledge of the data traffic to further optimize the power saving. In this particular case, the learning approach could be adopted to learn the patterns of data bursts that are more promising for power saving by releasing the link early. Particularly, the learning problem could be designed as a classification problem that takes the traffic info within a time window to predict if the idle time after the current burst-end is larger than a predefined threshold or not. If it is larger, it likely will save power if the link is released, otherwise it is counterproductive to release the link. In one embodiment, the information corresponding to the latest m (=k+1) data bursts may be chosen as the input feature for the learning problem. In one implementation, info about each burst may contain the burst-end time and the data-burst type

$$[ \begin{matrix}end time , burst type of burst n \\ ⋮ \\ end time , burst type of burst n - k\end{matrix} ] .$$

In another implementation, additional information about the burst may be computed and added. For example, the burst duration and the burst size (the amount of accumulated data during the burst). In this case, the input feature is as follow

$$[ \begin{matrix}end time , burst type , burst duration , and burst size of burst n \\ ⋮ \\ end time , burst type , burst duration , and burst size of burst n - k\end{matrix} ] .$$

FIG. 9 illustrates an example of how to obtain training data for a machine learning (ML) solution to determine whether the link could be released or not 900 according to embodiments of the present disclosure. The embodiment of the example of how to obtain training data for a machine learning (ML) solution to determine whether the link could be released or not 900 illustrated in FIG. 9 is for illustration only. Other embodiments of the example of how to obtain training data for a machine learning (ML) solution to determine whether the link could be released or not 900 could be used without departing from the scope of this disclosure.

The training data for this purpose can be collected automatically from past operation. An illustration of the process is shown in FIG. 9. During the initial period of using the app, the sequence of burst information according to the chosen implementation could be recorded as described above. Then the sequence of burst information could be broken down in segments containing m (=k+1) consecutive bursts. The label of each segment can be readily computed from the timing of the bursts. The start time of the burst (or equivalently the duration of the bursts) may be needed for the case when the burst duration is not recorded. This information can be easily computed from the recorded trace. If the duration between the end of the last burst of a segment and the start of the following burst (i.e., the burst interval) is larger than a predefined threshold T (e.g., 0.5, 1, 2, or 3 sec), then it is a positive label (meaning the link could be released), otherwise a negative label could be attached.

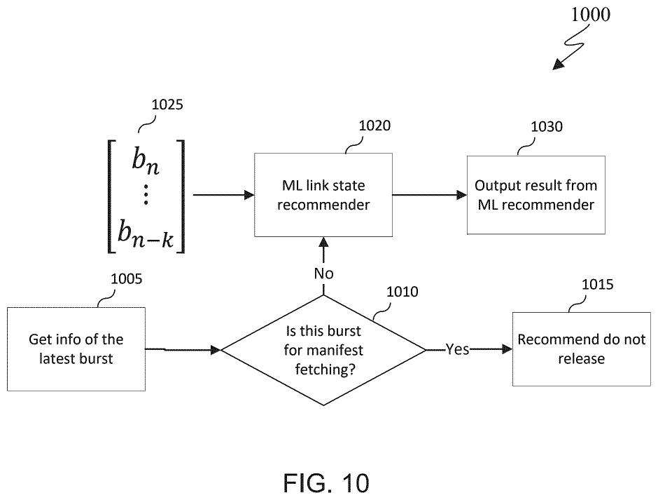

FIG. 10 illustrates an example 1000 where a ML recommender is combined with a rule-based solution derived from expert knowledge of the operation of the application and the finer-grained information from the application according to embodiments of the present disclosure. The embodiment of the example 1000 where a ML recommender is combined with a rule-based solution derived from expert knowledge of the operation of the application and the finer-grained information from the application illustrated in FIG. 10 is for illustration only. Other embodiments of the example 1000 where a ML recommender is combined with a rule-based solution derived from expert knowledge of the operation of the application and the finer-grained information from the application could be used without departing from the scope of this disclosure.

In some embodiments, the API could provide a finer granularity in terms of the data burst-type. In this case, the learning approach described above can still be applicable, but the additional sematic information about the burst type could be used to design a more efficient rule-based solution that exploits the knowledge of the underlying operation of the application. Taking the streaming example, consider the case when the app is fetching a video manifest (meta data for streaming) and after a small pause after the manifest is received, it starts another data burst to fetch the next video segment (or segments). In this situation, the app might indicate a burst-end after the completion of the fetching of the video manifest. If this is used to trigger a link release, it would be non-optimal if the start of the segment fetching happens a short while after (e.g., within less than 1 sec). By knowing the type of packets (e.g., that the fetched data is the video manifest) then the link status management process could make a proper decision thanks to the more complete information. In particular, if it is understood that the video segment should happen right after or a short period after the fetching of the video manifest, then there is no point to release the link. Therefore, in this case, this knowledge could be exploited to decide that the link should not be released at the burst-end of a video manifest fetching. An example embodiment following this is shown in FIG. 10. Here, only for the situations where the recommendation is clear from the semantic information such as whether this is a video manifest fetching that the ML recommender's output is overridden.

As illustrated in FIG. 10, information of the latest burst is obtained 1005. At 1010, a determination is made whether the burst is for manifest fetching. If the burst is for manifest fetching, then a recommendation can be made to not release the link at 1015. If the burst is not for manifest fetching, then the ML link state recommender 1020 may receive the set of information from the burst 1025, and the result from the ML link state recommender may be output 1030.

When app shares information and may also adapt its strategy for data communication: The main difference to the first category described above is that the app could be more proactive in the collaboration, and there could be API from both the app and modem side to exchange information for optimizing the performance.

The API by the app to share information with the modem could have finer details and information derived/inferred from its data communication strategy and internal status of the operation. The API may provide information in the following list. Additional or other information may also be provided. For ease of explanation, video streaming is used as an example when describing the information elements that could be shared in this API.
All information as described in the first category above
An indicator to convey if the app needs the data link or that it no longer does: One main difference to the burst-end indicator of the first category described above is that the app could make a smarter determination that accounts for what is to come. For example, the app may use its knowledge of the timing of all the maintenance/control packets and if the end of the current data burst is less than some time threshold (e.g., <1 sec) to next packets (e.g., like a control packet), then it declares that it still needs the data link. In this manner, it can help avoid an unnecessary link state transition.
The approximate time of the start of the next burst: A streaming protocol may set a target level for the buffer, and based on the current buffer status and the video manifest, the app could estimate the time when its video buffer could deplete to the level that may trigger the next segment fetching. Further, the app may also have knowledge of some packets for maintenance and control that could be periodic and thus their timing may also be known. All of these combined, the app could estimate the time when it needs the data link.
The amount of user data to be fetched in the next burst: Knowing the number of segments to be fetched (e.g., based on the app's buffer management policy) and the sizes of the segment (which could be available in the video manifest), the app could estimate the amount of video data to be fetched in the next burst.

The API for the modem/device to share information that could help the app optimize its communication management could include the following information:
Information about the physical layer of the cellular link: The information in this category may include the data throughput (this could be physical or MAC layer, etc.), level of temporal variation of the throughput, physical layer events of interest (e.g., a handover event), etc.
Anomaly conditions (of the cellular link): One particular example is when the NW throttles the wireless link. This could happen for various reasons and may depend on the data plan of the user.
Related sensor information such as mobility status (e.g., whether the device is in a static setting or in a moving setting such as in a car).

In some embodiments, one API that provides more control to the app to maintain the app experience is the indicator of whether the app needs or does not need the communication link (i.e., the app releases the link so that it can go to the idle state if the modem considers that is a good option). With this API, the modem can provide a guarantee that the communication stays in the connected state if the app indicates it needs the communication link. If the app indicates it does not need the communication link, the modem could check other conditions (e.g., the background traffic and traffic shaping buffer, etc.) and if there is no time-critical task and power saving can be expected, then the modem may release the link. With this API, the app can use its knowledge to avoid cases with short interval until the next upcoming data bursts (i.e., less than 1 sec like as described herein with reference to FIG. 8). Further, the app may also choose to keep the link in standby for situations where there could be a pause in the communication due to the server and/or some link in the data network (besides the cellular wireless link). The app may also keep the communication link in the connected state should it consider that the delay in the link reestablishment (which typically may take up to a few hundred milliseconds) could cause user experience degradation. All these examples illustrate some situations where the app could leverage this API to optimize its user experience while at the same time provide opportunities for the modem to save power. The power saving by the modem would prolong the battery and thus the length of time the app can service the user and thus this is also an important part of improving the user experience.

With the app able to indicate whether it needs the data link or not, it presents opportunities to optimize the handling of other background packets. A situation of interest is when the modem detects a data-burst end (e.g., due to the pause in data activities) but the app indicates it still needs the data link and that it should not be released. In this case, there is an unknown amount of idle time in the connected state that could be used to send out the non-urgent background traffics. For each of these background traffics, depending on the app that generates them, it could be possible to estimate the amount of data (and thus the time it would occupy the data link) that it may need to send. If the time for sending out a set of background packets from a particular app could likely be completed within this gap time, then that set of packets could be scheduled for better efficiency. As these background traffics by definition are not time critical, when the app has some data to be exchanged, those can preempt the background traffic. Thus, negligible impact on the app user experience due to the use of the gap time this way may be expected. However, if those background packets would need to be retransmitted at a later time (due to incomplete transmission by the preemption of the foreground app), it would be inefficient as those transmitted packets during the gap time that were preempted are wasted; i.e., causing extra power consumption instead of saving power. Therefore, the selected group or set of background packets may need to be selected properly to ensure that overall power saving can be expected. To make this determination, it may be desirable to have both the expected duration (or amount of data) to complete the transmission of a set of background packets (e.g., the set could be packets for a particular task from a particular app) and the expected length of the current gap time. The amount of data to be sent for a given task could be known from the information attached with the task/job, which could be available to the operating system of the device. As noted herein, the duration of this gap time could be unknown, and a learning approach could be adopted to learn from the behavior of the app. To estimate the duration of the current gap time, a similar approach to the ML link release recommender described above could be used. Specifically, a similar procedure for generating the training data as illustrated in FIG. 9 may be used. The difference is that instead of the binary label (either P [positive] or N [negative]), that label may be replaced by the length of the gap time. This would become a regression problem instead of a classification problem. Depending on the device constraint (i.e., due to a limit in the amount of training data), this could be simplified to a classification problem by quantizing the gap time into a set of interval values.

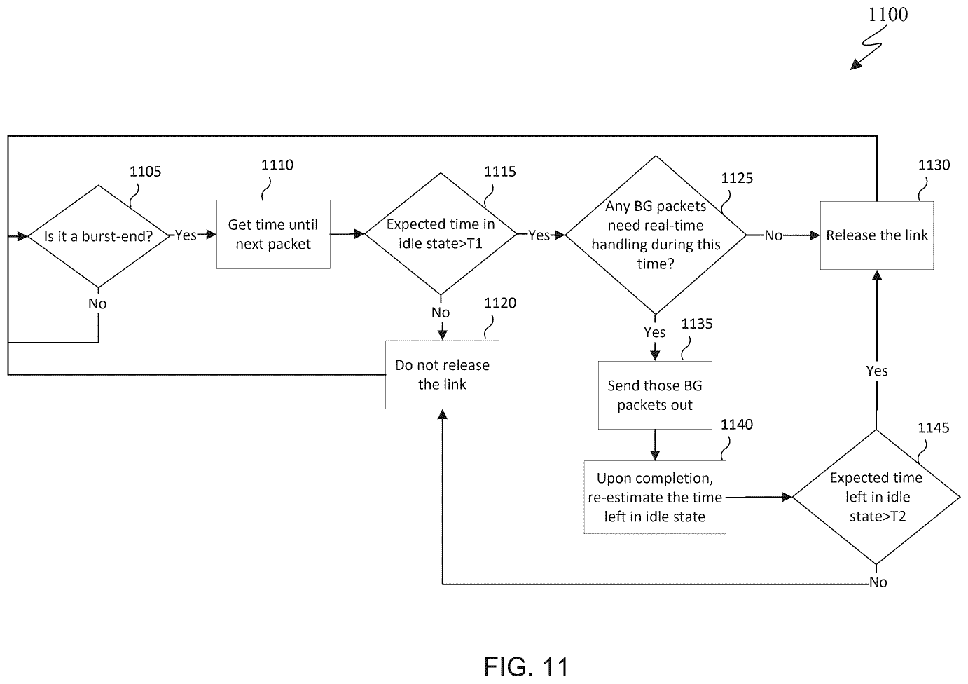

FIG. 11 illustrates an example 1100 for managing the link connection status using the estimated time that the application will not need the communication link according to embodiments of the present disclosure. The embodiment of the example 1100 for managing the link connection status using the estimated time that the application will not need the communication link illustrated in FIG. 11 is for illustration only. Other embodiments of the example 1100 for managing the link connection status using the estimated time that the application will not need the communication link could be used without departing from the scope of this disclosure.

In some embodiments, the application may be able to determine when its next data packet will be after the current data burst. For example, for a streaming application, especially during the stable state, the timing of the next packet after the current data burst may be determined from the timing of various control packets (e.g., for maintaining the link which could be periodic) and the video buffer status. With this kind of information from the app, the determination of whether to release the link becomes simpler. In this case, the app can provide both the burst end timing and an estimate of time it will not need to use the communication link (i.e., time until the next packet). The modem only needs to consider the requirement from the background packets to make the final determination. For example, if there is no background packet requiring real-time handling (or becomes expired) within this expected idle duration of the app, then the link may be released. An embodiment of the procedure is illustrated in FIG. 11. By providing this expected time to the next packet to the modem, the modem could ensure the link would become connected (i.e., having the fastest response time) which could reduce the latency (especially in situations where the link reestablishment could fail with some non-negligible probability) making the communication for the app smoother (which could contribute to better app experience).

As illustrated in FIG. 11, a determination is made whether a burst end has been reached at 1105. If no burst end has been reached, then the procedure reverts to 1105. If a burst end has been reached, then the time until the next packet is obtained at 1110. A determination is made whether an expected time in an idle state exceeds a threshold at 1115. If the expected time in the idle state does not exceed the threshold, then the link is not released at 1120, and the procedure reverts to 1105. If the expected time in the idle state does exceed the threshold, then a determination is made whether any background packets need real time handling during this time at 1125. If no background packets need real time handling during this time, then the link is released at 1130, and the procedure reverts to 1105. If background packets need real time handling during this time, then those background packets are sent out at 1135. Upon completion of sending the packets out, the time left in the idle state is re-estimated at 1140. A determination is made whether the expected time left in the idle state exceeds a second threshold at 1145. If the expected time left in the idle state does not exceed the second threshold, then the link is not released at 1120, and the procedure reverts to 1105. If the expected time left in the idle state does exceed the second threshold, then the link is released at 1130, and the procedure reverts to 1105.

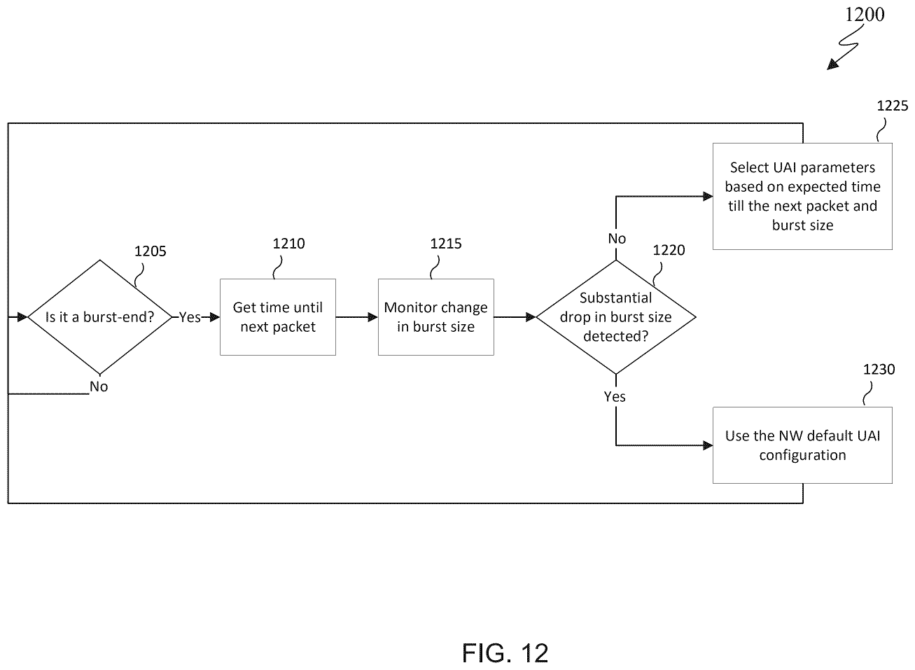

FIG. 12 illustrates an example 1200 that leverages the burst size estimate provided by the application to adjust the UAI parameters for UE power saving according to embodiments of the present disclosure. The embodiment of the example 1200 that leverages the burst size estimate provided by the application to adjust the UAI parameters for UE power saving illustrated in FIG. 12 is for illustration only. Other embodiments of the example 1200 that leverages the burst size estimate provided by the application to adjust the UAI parameters for UE power saving could be used without departing from the scope of this disclosure.

In some embodiments, the app may provide not only the timing of the next packet but also the estimated amount of data to be sent in the next burst. The app may estimate the amount of data in the next burst using its knowledge of the underlying operation of its data communication. For example, consider a video streaming application, if the data is for some control purposes (e.g., link maintenance), then it can be expected that the amount of data could be relatively small. If the burst is for delivering the video segment, the data size could be available in the video manifest. Armed with this knowledge, the modem could leverage the UAI feature of the 3GPP Release 16 to further optimize the cellular configuration to reduce the power consumption. Particularly, using the estimated burst size and the allowable time to determine the UAI parameters (e.g., the max aggregated bandwidth, the max number of CCs, the max number of MIMO layers, CDRX parameters, etc.) that could save the power while completing the data delivery within the allowed time. In many cases, the allowed time budget could be selected to be the time until the next packet indicated by the app, possibly with some margin to be on the safe side. However, if the app does some other monitoring (e.g., monitoring the current throughput) that is not known to the modem for managing data communication, some adverse effect may happen. For example, consider a video streaming application. If the app measures the throughput and it requires that the throughput be larger than some threshold to select some resolution quality. If the selected UAI parameters cause the estimated throughput to fall, it may trigger a downgrading of the resolution. In this case, if the app could provide another API to provide the quality of the app (e.g., the current resolution of the video which is readily available in the app), the UAI parameter selector could adjust accordingly. If not available, then the UAI parameter selection can estimate the quality. One approach is to detect for a substantial drop in the burst size as illustrated FIG. 12. While this may not be accurate as the size of each data segment could depend on the actual content, this could be a simple solution, yet it can capture most of the gains. In this usage, knowing the precise size may not be as critical as the UAI selector could choose the appropriate granularity of the UAI parameters accordingly.

As illustrated in FIG. 12, a determination is made whether a burst end has been reached at 1205. If no burst end has been reached, then the procedure reverts to 1205. If a burst end has been reached, then the time until the next packet is obtained at 1210. The change in burst size is monitored at 1215. A determination is made whether a substantial drop in burst size is detected at 1220. If a substantial drop in burst size is not detected, then UAI parameters can be selected based on the expected time until the next packet and burst size at 1225, and then the procedure reverts to 1205. If a substantial drop in burst size is detected, then the network default UAI configuration can be used at 1230, and then the procedure reverts to 1205.

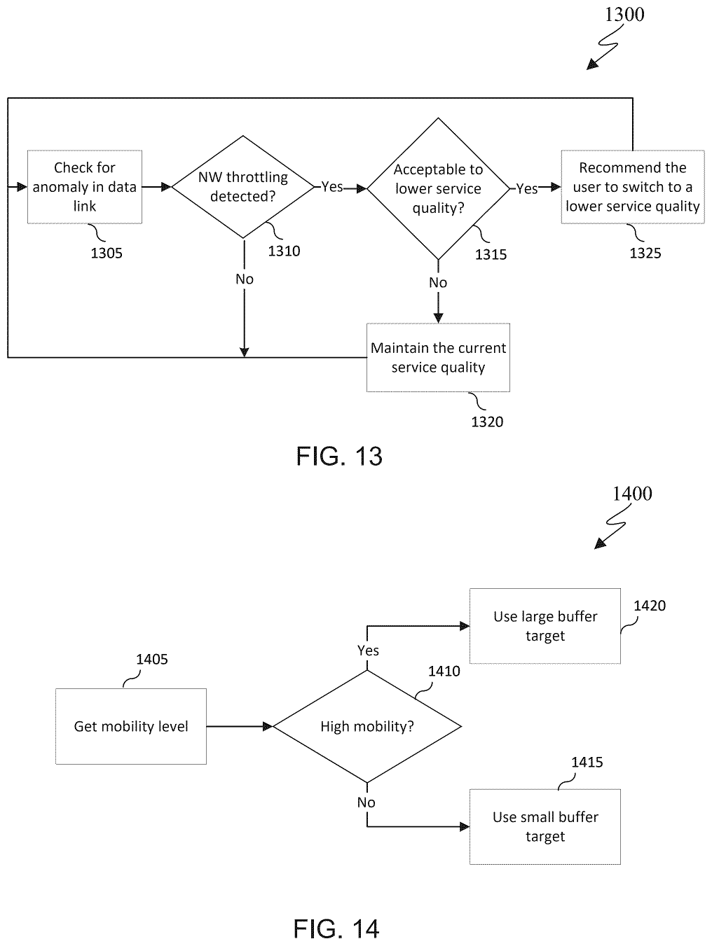

In some embodiments, the modem may also implement some API that could provide useful information for the app to optimize their data communication usage. For clarity, we will discuss based on video streaming as an example. For many commercial cellular services, some restriction could be imposed depending on the selected data plan. For example, under certain conditions, the network may throttle the throughput of the mobile device. This could cause the download time for a data burst for the next video segment to occupy most or all of the time until the next data burst. That is the traffic pattern would no longer be bursty in this case. This causes undesirable outcomes for both the streaming app and the modem. For the streaming app, this means there is little video buffer that can be accumulated and thus it becomes more prone to video stalling. For the modem, this means the device has to be in the connected state the entire time that the video is playing, which results in more power consumption. To mitigate this situation, if the modem can indicate to the app that throughput throttling is detected, then the app may display a pop-up to recommend the user to lower the video resolution for a smoother video playing experience (and reduce power consumption). Note that the app may make the determination of whether it is better to lower the resolution or take the risk of stalling. Taking the risk of stalling makes sense when the resolution at the time when throttling is applied is already considered low for the device (e.g., based on the screen size of the device). Further or alternatively, in the case of throttling, the modem could adjust its UAI parameters to fit with the throttled data rate to avoid using more resources than needed (e.g., using a larger bandwidth, number of MIMO layers, etc.). An example embodiment is illustrated in FIG. 13.

FIG. 13 illustrates an example 1300 where network throttling may be detected by the modem/device and shared with the application according to embodiments of the present disclosure. The embodiment of the example 1300 where network throttling may be detected by the modem/device and shared with the application illustrated in FIG. 13 is for illustration only. Other embodiments of the example 1300 where network throttling may be detected by the modem/device and shared with the application could be used without departing from the scope of this disclosure.

As illustrated in FIG. 13, a check for an anomaly in the data link is made at 1305, and a determination is made whether network throttling is detected at 1310. If network throttling is not detected, then the procedure reverts to 1305. If network throttling is detected, then a determination is made whether it is acceptable to lower the service quality at 1315. If it is not acceptable to lower the service quality, then the service quality can be maintained at 1320, and the procedure reverts to 1305. If it is acceptable to lower the service quality, then a recommendation to switch the user to a lower service quality can be made at 1325, and the procedure reverts to 1305.

In some embodiments, the device may provide a mobility state to the app. Consider the case of high mobility (e.g., driving) and that video streaming is the application. The high mobility means that the wireless link performance could fluctuate rapidly. This could mean the delivery of the next data burst might or might not be completed in time. One strategy to deal with this is to choose to use a larger target value for the video buffer than in the low mobility case as shown in FIG. 14. This way, there will likely be enough margin to counter the duration where the wireless link could be bad. In some cases, the data consumption amount is of concern and there is a need to balance the buffer target and potential waste of data. In such a case, the strategy for adjusting the buffer target could also account for the probability that the user may skip the video to avoid wasting the downloaded buffer. For example, rather than using a fixed buffer target, an incremental adjustment could be adopted. If the user stays with the video after the fetching of a segment, the target buffer could be increased and this repeats until the max target buffer is reached.

FIG. 14 illustrates an example 1400 for managing the streaming video buffer using the mobility status from the modem/device's API according to embodiments of the present disclosure. The embodiment of the example 1400 for managing the streaming video buffer using the mobility status from the modem/device's API illustrated in FIG. 14 is for illustration only. Other embodiments of the example 1400 for managing the streaming video buffer using the mobility status from the modem/device's API could be used without departing from the scope of this disclosure.

As illustrated in FIG. 14, the mobility level may be obtained at 1405. A determination is made whether the device is in a state of high mobility at 1410. If the device is not in a state of high mobility, then a small buffer target may be used at 1415. If the device is in a state of high mobility, then a large buffer target may be used at 1420.

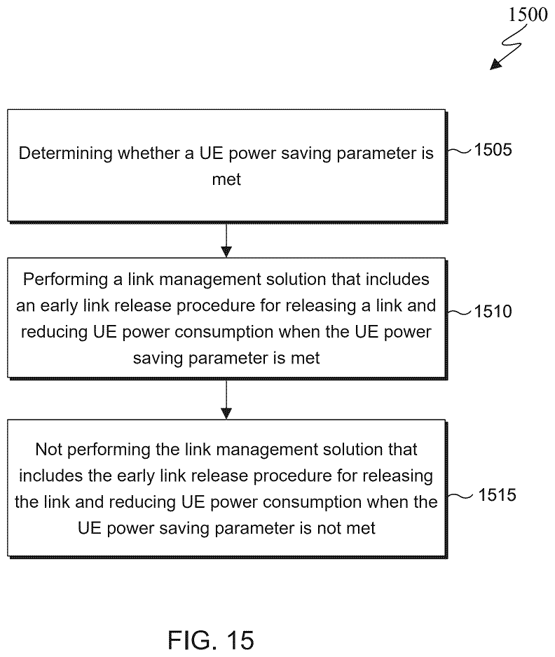

FIG. 15 illustrates an example method 1500 for adaptive link status and configuration per the application traffic pattern for UE power saving according to embodiments of the present disclosure. The embodiment of a method 1500 for adaptive link status and configuration per the application traffic pattern for UE power saving shown in FIG. 15 is for illustration only. Other embodiments of a method 1500 for adaptive link status and configuration per the application traffic pattern for UE power saving could be used without departing from the scope of this disclosure. The method 1500 can be performed by a UE.

As illustrated in FIG. 15, the method 1500 begins at step 1505, where a determination is made whether a UE power saving parameter is met. When the UE power saving parameter is met at step 1510, a link management solution is performed that includes an early link release procedure for releasing a link and reducing UE power consumption. When the UE power saving parameter is not met at step 1515, the link management solution that includes the early link release procedure for releasing the link and reducing UE power consumption is not performed.

In one embodiment, the UE is configured to determine that data traffic is discontinuous.

In one embodiment, the UE configured to determine that a target application is active.

In one embodiment, the UE is configured to: perform a link release procedure for releasing the link; and perform a background traffic management procedure for managing background traffic.

In one embodiment, the link is not in a connected state, and the UE is configured to: segregate foreground traffic from background traffic; initiate establishment of the link for the foreground traffic; determine whether the background traffic is time sensitive; when the background traffic is time sensitive, initiate establishment of the link for the background traffic; and when the background traffic is not time sensitive, adjust a timing of background traffic transmission.

In one embodiment, the link is in a connected state, and the UE is configured to: determine whether a data burst end has been reached; and release the link in the connected state or not release the link in the connected state based on the data burst end determination.

In one embodiment, the UE is configured to exchange information with the target application related to data communication of the target application.

In one embodiment, the UE is configured to: receive an indication of a data burst end; or receive an indication of a data burst type.

In one embodiment, the UE is configured to: receive an indication of a need for maintaining the link in the connected state; or receive an indication of a start time of a subsequent data burst; or receive an indication of an amount of user data to be fetched in a subsequent data burst; or transmit information about a physical layer of the link; or transmit information about an anomaly condition of the link; or transmit information about a mobility status of the UE.

In one embodiment, the link release procedure includes a machine learning procedure.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
determining whether a UE power saving parameter is met;
when the UE power saving parameter is met, performing a link management solution that includes an early link release procedure for releasing a link and reducing UE power consumption; and
when the UE power saving parameter is not met, not performing the link management solution that includes the early link release procedure for releasing the link and reducing UE power consumption.

2. The method of claim 1, wherein determining whether the UE power saving parameter is met comprises determining that data traffic is discontinuous.

3. The method of claim 2, wherein determining that the data traffic is discontinuous comprises determining that a target application is active.

4. The method of claim 3, wherein performing the link management solution comprises:
performing a link release procedure for releasing the link; and
performing a background traffic management procedure for managing background traffic.

5. The method of claim 4, wherein the link is not in a connected state, and the background traffic management procedure comprises:
segregating foreground traffic from background traffic;
initiating establishment of the link for the foreground traffic;
determining whether the background traffic is time sensitive;
when the background traffic is time sensitive, initiating establishment of the link for the background traffic; and
when the background traffic is not time sensitive, adjusting a timing of background traffic transmission.

6. The method of claim 4, wherein the link is in a connected state, and the link release procedure comprises:
determining whether a data burst end has been reached; and
releasing the link in the connected state or not releasing the link in the connected state based on the data burst end determination.

7. The method of claim 6, further comprising exchanging information with the target application related to data communication of the target application.

8. The method of claim 7, wherein exchanging information with the target application comprises:
receiving an indication of a data burst end; or
receiving an indication of a data burst type.

9. The method of claim 7, wherein exchanging information with the target application comprises:
receiving an indication of a need for maintaining the link in the connected state; or
receiving an indication of a start time of a subsequent data burst; or
receiving an indication of an amount of user data to be fetched in a subsequent data burst; or
transmitting information about a physical layer of the link; or
transmitting information about an anomaly condition of the link; or
transmitting information about a mobility status of the UE.

10. The method of claim 6, wherein the link release procedure includes a machine learning procedure.

11. A user equipment (UE) comprising:
a transceiver; and
a processor operably coupled to the transceiver, the processor configured to:
determine whether a UE power saving parameter is met;
when the UE power saving parameter is met, perform a link management solution that includes an early link release procedure for releasing a link and reducing UE power consumption; and
when the UE power saving parameter is not met, not perform the link management solution that includes the early link release procedure for releasing the link and reducing UE power consumption.

12. The UE of claim 11, wherein to determine whether the UE power saving parameter is met, the processor is further configured to determine that data traffic is discontinuous.

13. The UE of claim 12, wherein to determine that the data traffic is discontinuous, the processor is further configured to determine that a target application is active.

14. The UE of claim 13, wherein to perform the link management solution, the processor is further configured to:
perform a link release procedure for releasing the link; and
perform a background traffic management procedure for managing background traffic.

15. The UE of claim 14, wherein the link is not in a connected state, and to perform the background traffic management procedure, the processor is further configured to:
segregate foreground traffic from background traffic;
initiate establishment of the link for the foreground traffic;
determine whether the background traffic is time sensitive;
when the background traffic is time sensitive, initiate establishment of the link for the background traffic; and
when the background traffic is not time sensitive, adjust a timing of background traffic transmission.

16. The UE of claim 14, wherein the link is in a connected state, and to perform the link release procedure, the processor is further configured to:
determine whether a data burst end has been reached; and
release the link in the connected state or not release the link in the connected state based on the data burst end determination.

17. The UE of claim 16, wherein the processor is further configured to exchange information with the target application related to data communication of the target application.

18. The UE of claim 17, wherein to exchange information with the target application, the processor is further configured to:
receive an indication of a data burst end; or
receive an indication of a data burst type.

19. The UE of claim 17, wherein to exchange information with the target application, the processor is further configured to:
receive an indication of a need for maintaining the link in the connected state; or
receive an indication of a start time of a subsequent data burst; or
receive an indication of an amount of user data to be fetched in a subsequent data burst; or
transmit information about a physical layer of the link; or
transmit information about an anomaly condition of the link; or
transmit information about a mobility status of the UE.

20. The UE of claim 16, wherein the link release procedure includes a machine learning procedure.
